(19) United States
(12) Patent Application Publication
(10) Pub. No.: US 2012/0265503 A1
(43) Pub. Date: Oct. 18, 2012

(54) ENERGY CONSUMPTION SIMULATION

(76) Inventors: Oliver Bendig, Forst (DE); Klaus Kistl, Weisloch (DE); Sandra Mangano, Sandhausen (DE)

(21) Appl. No.: 13/084,575

(22) Filed: Apr. 12, 2011

(51) Int. Cl. G06G 7/48

(52) U.S. Cl. 703/6

(57) ABSTRACT

Various embodiments of systems and methods for simulating energy consumption for a simulation period are described herein. Realized energy consumption profile values for time slices of a simulation period are retrieved. Prior realized energy consumption profile values from corresponding time slices of consecutive previous calendar periods for time slices of the simulation period for which the realized energy consumption profile values are not available are retrieved. Further, time slices of the simulation period for which the corresponding prior realized profile values are not available are identified. For the identified time slices, an estimation of the unrealized energy profile values is computed using synthetic profile values. Furthermore, retrieved realized energy consumption profile values, retrieved prior realized energy consumption profile values, and estimated unrealized energy profile values are used to simulate energy consumption for the simulation period.

### FIELD

Embodiments generally relate to computer systems and more particularly to methods and systems for simulating energy consumption for a simulation period.

### BACKGROUND

With the introduction of smart meters (e.g., advanced metering infrastructure meters, energy consumption measurement meters, and the like that communicate energy consumption to remote recipients via networks), an economical way of measuring energy consumption is achieved. Generally, the smart meters record energy consumption at regular intervals and communicate the recorded information back to the utility models. Also, some smart meters forward the read-out energy consumption to the utility models. Further, the received information by the utility models are used for multiple purposes such as monitoring and billing of the energy consumption, which is useful for water, sewer, gas, and electric utility billers. Further, the reading of the smart meter provides information on energy consumption behavior of a customer and the information is stored as energy consumption profile values (e.g., energy consumption for each 15 minutes are stored). The customer can be inhabitants of apartment houses, commercial buildings, companies, and the like. This enables energy providers to introduce different prices depending on the energy consumption at different time periods. Therefore, billing of the energy consumption profile values allows much more flexibility in the creation of bills depending on time periods (e.g., weekdays, weekends, morning, evening, and the like) in terms of shaping interest rates, providing discounts and the like.

With this new flexibility in the billing, new tariffs can be created by the energy providers. In order to get the best rate, the customer may want to simulate different tariffs based on the energy consumption profile values. For the simulation, energy consumption profile values should be available in a system. The simulation of the energy consumption can be achieved if the customer is known in the system or in other words, if the energy consumption profile values associated with the customer exists. On the other hand, if the customer is quite new or if the existing energy consumption profile values associated with the customer do not exist or are not relevant, there are no methods and systems for simulating energy consumption.

In general, in order to provide the best rate to the customer by the energy providers and to plan the energy consumption by the customer, billing simulations based on the energy consumption profile values are needed. However, the profile values associated with the customer are not always available or the available profile values may be not relevant. Is therefore desirable to provide a method and system for simulating energy consumption where the customer is not known to the system.

### SUMMARY

Various embodiments of systems and methods for simulating energy consumption for a simulation period are described herein. In one aspect, realized energy consumption profile values for time slices of the simulation period are retrieved. Also, prior realized energy consumption profile values from corresponding time slices of consecutive previous calendar periods for time slices of the simulation period for which the realized energy consumption profile values are not available are retrieved. Further, one or more time slices of the simulation period for which the corresponding prior realized profile values are not available are identified. For the identified time slices, an estimation of the unrealized energy profile values is computed using synthetic profile values. Furthermore, the retrieved realized energy consumption profile values of the simulation period, the retrieved prior realized energy consumption profile values of the consecutive previous calendar periods, and the estimated unrealized energy profile values of the simulation period are used to simulate energy consumption for the simulation period.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method of simulating energy consumption of a simulating period, according to an embodiment.

FIG. 2 is a conceptual block diagram of the method of FIG. 1, according to an embodiment.

FIG. 3 is a flow diagram illustrating a method of estimating unrealized profile values of a simulation period, according to an embodiment.

FIG. 4 is an exemplary timeline diagram illustrating simulating energy consumption of a simulation period, according to an embodiment.

FIG. 5 is another exemplary timeline diagram illustrating simulating energy consumption of a simulation period, according to an embodiment.

FIG. 6 is yet another exemplary timeline diagram illustrating simulating energy consumption of a simulation period, according to an embodiment.

FIG. 7 is a timeline diagram illustrating interpretation of energy consumption corresponding to a period for retrieving prior realized energy consumption profile values of consecutive previous calendar periods corresponding to a simulation period, according to an embodiment.

FIG. 8 is a block diagram illustrating a computing environment in which the techniques described for simulating energy consumption of a simulation period, according to an embodiment.

### DETAILED DESCRIPTION

Embodiments of techniques for simulating energy consumption for a simulation period, associated with a customer, are described herein. Energy is a measure or a quantity used to do different kinds of work. Energy can be of different forms based on the way energy is perceived (e.g., mechanical energy, electrical energy, energy of light, and the like), based on the origins of energy (e.g., nuclear energy, hydraulic energy, wind energy, geothermal energy, solar energy, and the like), and other forms such as thermal energy. Energy simulation is a computer based analytical process, which helps both customers and energy providers to evaluate energy consumption behavior. The simulation period is a period for which the energy consumption needs to be simulated.

According to an embodiment, for simulating energy consumption of the simulation period, realized energy consumption profile values for time slices of a simulation period are retrieved. Also, prior realized energy consumption profile values from corresponding time slices of consecutive previous calendar periods for time slices of the simulation period for which the realized energy consumption profile values are not available are retrieved. Further, for time slices for which the prior realized energy consumption profile values are not available, an estimation of the unrealized energy profile values using synthetic profile values are computed. Furthermore, the retrieved realized energy consumption profile values, the retrieved prior realized energy consumption profile values, and the estimated unrealized energy profile values are used to simulate energy consumption for the simulation period. Thereby, an accurate prognosis of the expected energy consumption behavior is achieved in a realistic manner and can be used in utility billing process, for instance.

In one exemplary embodiment, electrical energy is taken as an example for describing the method and system for simulating energy consumption of the simulation period. However, it is appreciated that the method can be implemented for simulating other forms of the energy consumption.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

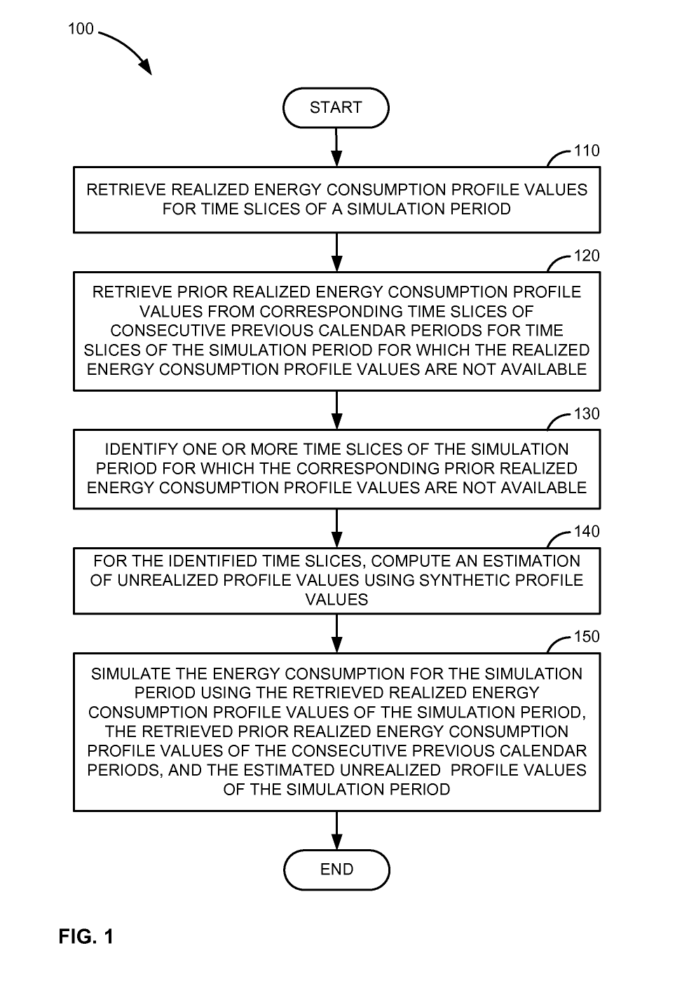

FIG. 1 is a flow diagram 100 illustrating a method of simulating energy consumption of a simulation period, according to an embodiment. At step 110, realized energy consumption profile values for time slices of the simulation period are retrieved. In one embodiment, the realized energy consumption profile values are billable values measured within the simulation period, which are stored in an interval register associated with the customer. For example, if the energy consumption has to be simulated for the year 2011, the realized energy consumption profile values available within the year 2011 are retrieved.

At step 120, prior realized energy consumption profile values from corresponding time slices of consecutive previous calendar periods for time slices of the simulation period for which the realized energy consumption profile values are not available are retrieved. In one embodiment, the prior realized energy consumption profile values are defined as billable values measured within the consecutive previous calendar periods corresponding to the simulation period, which are stored in the interval register associated with the customer. In one exemplary embodiment, the prior realized energy consumption profile values are retrieved from the time slices shifted by 364 days (i.e., 52 weeks) of the simulation period to make sure that the day of a week is not changed (e.g., retrieved in such a way that weekends and weekdays are matched, to achieve retrieving accurate energy consumption).

In one embodiment, retrieving the prior realized energy consumption profile values is based on one or more factors including a contract, an installation and energy consumption corresponding to a period. The contract is defined as a binding agreement between an energy provider and the customer. The installation refers to an energy meter or device installed for the customer to record the energy consumption at regular interval of time periods (e.g., for every 15 minutes and the like). Further, the energy consumption corresponding to the time periods are assigned to the interval register associated with the customer by an authorized person of the energy provider after inspecting energy consumption behavior of the customer (e.g., based on the consecutive previous calendar periods energy consumption associated with the customer or inspecting devices associated with the customer which requires energy consumption, or the like).

For example, for simulating energy consumption for the year 2011, the realized energy consumption profile values available within the year 2011 are retrieved first. If the realized energy consumption profile values are available only for time slices of January 2011 to March 2011, then for remaining time slices (i.e., April 2011 to December 2011), the prior realized energy consumption profile values are retrieved from the consecutive previous calendar periods (i.e., April 2010 to December 2010) corresponding to April 2011 to December 2011. However, before retrieving the prior realized energy consumption profile values, the one or more factors (e.g., the contract, the installation and the energy consumption corresponding to the period, associated with the consecutive previous calendar periods) are checked. Based on the one or more factors, the prior realized energy consumption profile values are retrieved from the consecutive previous calendar periods corresponding to the simulation period.

In one exemplary embodiment, the prior realized energy consumption profile values from the consecutive previous calendar periods may not be retrieved if the prior realized energy consumption profile values of the consecutive previous calendar periods status is lost due to archiving, for instance. Further, the prior realized energy consumption profile values from the consecutive previous calendar periods may not be accepted if no contract (i.e., contract between the customer with the metering device (in other words, the interval register) and the energy provider) exists for the consecutive previous calendar periods corresponding to the simulation period . In one exemplary embodiment, the interval register may or may not be associated with same customer for which the simulation of the energy consumption is composed. In other words, the prior realized energy consumption profile values of the consecutive previous calendar periods associated with different customer are accepted, but the prior realized energy consumption profile values of the consecutive previous calendar periods for which the contract does not exist may not be accepted. However, even if the contract exists, the customer may not be associated with the contract (e.g., vacant apartment with no tenant, however the contract exists), such contract is known as a dummy contract (e.g., dummy contract is defined to bill the trivial energy consumption to the apartment owner). In one exemplary embodiment, such dummy contracts are excluded.

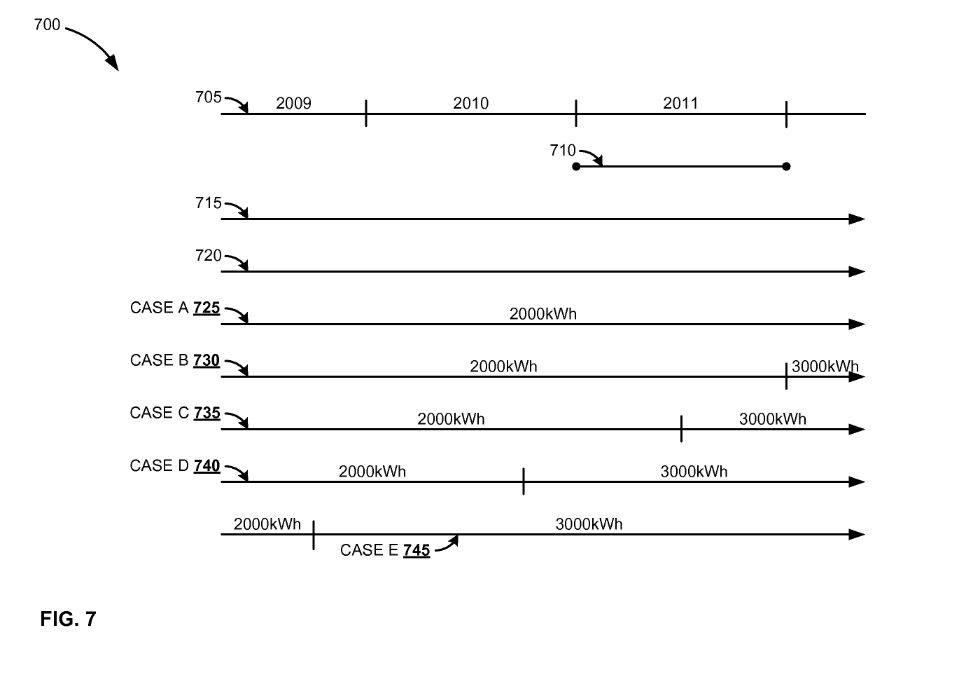

Furthermore, the energy consumption corresponding to the period associated with the interval register of the customer is checked. The prior realized energy consumption profile values that are older than the last change of the energy consumption corresponding to the period are not retrieved. Retrieving the prior realized energy consumption profile values of the consecutive previous calendar period based on the energy consumption corresponding to the period is described in greater detail in FIG. 7.

In one exemplary embodiment, if the prior realized energy consumption profile values are not available in the consecutive previous calendar period corresponding to the simulation period , the prior realized energy consumption profile values are retrieved from the second to last calendar period (i.e., retrieved by shifting by 2×364=728 days corresponding to the simulation period), provided the prior realized energy consumption profile values are available for the second to last calendar period of the simulation period and after checking the one or more factors.

At step 130, one or more time slices of the simulation period for which the corresponding prior realized energy consumption profile values are not available are identified. For example, for simulating the energy consumption for the year 2011, if the prior realized energy consumption profile values are available for the months of March 2011 to September 2011, the remaining time slices (i.e., October 2011 to December 2011) are identified (considering realized energy consumption profile values are available for the months January 2011 and February 2011). At step 140, for the identified time slices, an estimation of unrealized profile values are computed using synthetic profile values. For example, the unrealized profile values for the months of September 2011 to December 2011 are estimated.

In one embodiment, the synthetic profile values are predicted arbitrary energy consumption profile values, created based on multiple energy consumption patterns. Further, the customer is assigned with a synthetic profile depending on the energy consumption pattern relevant for the customer. In other words, the synthetic profile represents energy consumption pattern of the customer, assigned to a Time of Use (TOU) interface. The TOU interface defines how profile values have to be billed (e.g., for calculating different prices for different time period such as weekdays, weekends, daytime, nighttime and the like). Further, there can be different synthetic profiles for different energy consumption behaviors. For example, synthetic profiles corresponding to ‘residential customer having a family where cooking is done during afternoon’, ‘a single person who works all day and watches TV in the evening’, and the like are created. In one exemplary embodiment, the synthetic profile includes the synthetic profile values for regular intervals (similar to the intervals of the meter reading) such as for every 15 minutes and the like.

At step 140, the retrieved realized energy consumption profile values of the simulation period (e.g., as described in step 110), the retrieved prior realized energy consumption profile values of the consecutive previous calendar periods (e.g., as described in step 120), and the estimated unrealized profile values of the simulation period (as described in step 140) are used to simulate energy consumption for the entire simulation period. In one exemplary embodiment, the realized energy consumption profile values, the retrieved prior realized energy consumption profile values, and the estimated unrealized profile values can be stored as simulated energy consumption profile values to monitor the energy consumption corresponding to each time of the simulation period, which can be used to execute different kind of energy consumption billing rate for the simulation period.

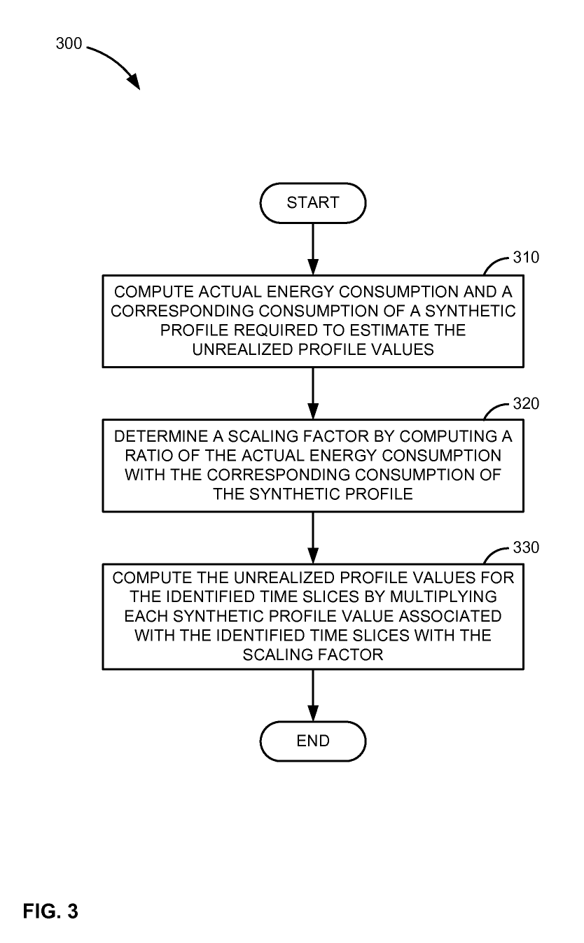

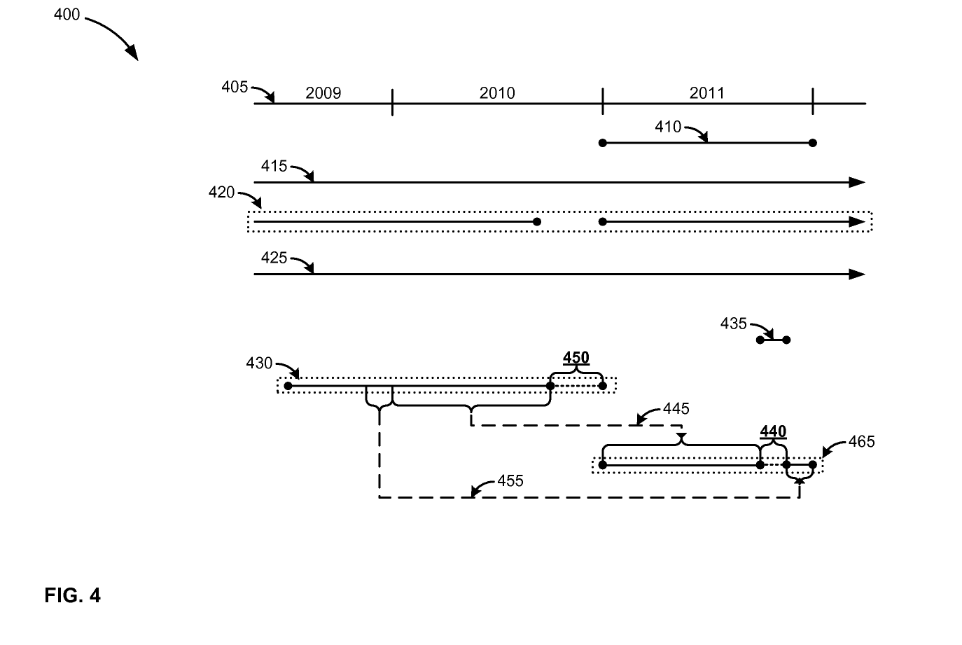

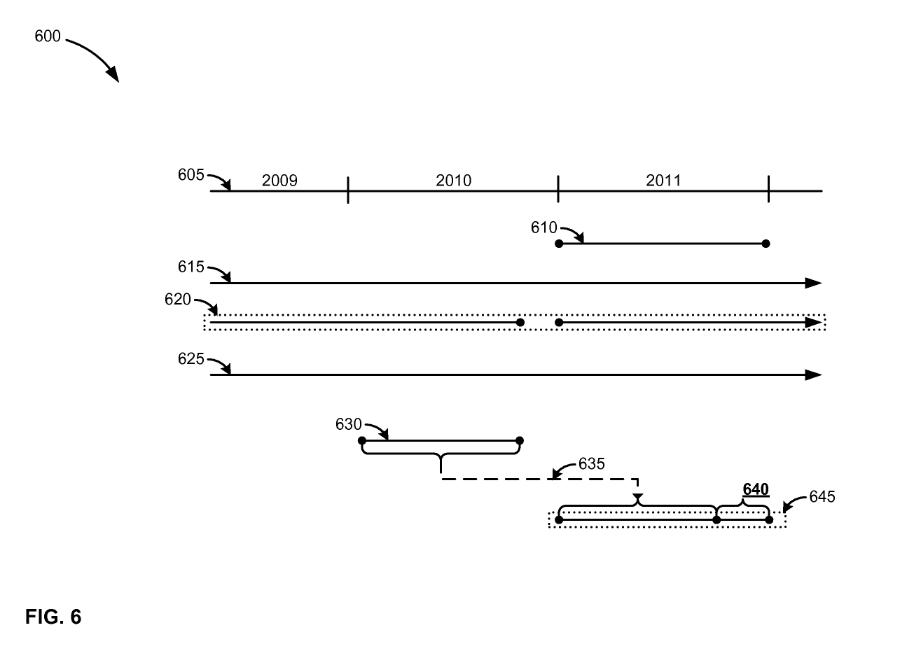

In one embodiment, if a relevant billing disconnection exists within the simulation period, the unrealized profile values associated with the time slices of such disconnection period of the simulation period is taken as zero. In other words, the customer can declare the disconnection for a period of time. For example, if the customer declares that the disconnection exists in August 2011 (since the customer may go for an outing in August 2011, energy consumption for August 2011 is zero), then for simulating energy consumption for the year 2011, the prior realized energy consumption profile values for the month of August 2011 are neither retrieved nor estimated. The unrealized profile values for August 2011 are set as zero. Retrieving the realized energy consumption profile values and the prior realized energy consumption profile values are described in greater detail with an example in FIGS. 4 and 6. Further, estimating the unrealized profile values is described in greater detail in FIGS. 3, 5 and 6.

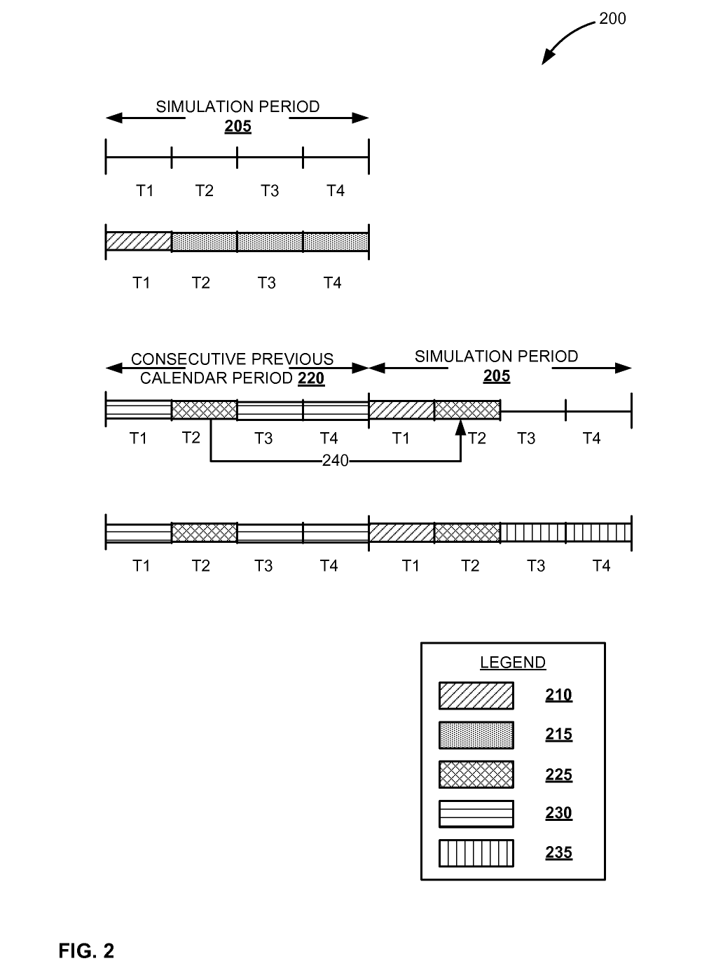

FIG. 2 is a conceptual diagram 200 of the method of FIG. 1, according to an embodiment. The conceptual diagram 200 describes simulation of energy consumption for a simulation period 205, corresponding to a customer. The simulation period 205 includes one or more time slices (e.g., T1, T2, T3, and T4). The realized energy consumption profile values are available for a time slice T1 210 of the simulation period 205. Further, the realized energy consumption profile values are not available for time slices T2, T3 and T4 215. Firstly, the realized energy consumption profile values for the time slice T1 210 are retrieved.

Further, for the remaining time slices for which the realized energy consumption profile values are not available (e.g., T2, T3, and T4 215) are retrieved from prior realized energy consumption profile values from consecutive previous calendar period 220 corresponding to the simulation period 205 (e.g., the prior realized energy consumption profile values of T2 of the consecutive previous calendar period 220 is copied to the time slice T2 of the simulation period 205). Before retrieving the prior realized energy consumption profile values, one or more factors such as an installation, a contract, and energy consumption corresponding to a period are checked. The installation and the contract are considered that they exit starting from the consecutive previous calendar period 220, and the energy consumption for the period is considered constant from the starting of the consecutive previous calendar period 220. Therefore, the prior realized energy consumption profile values available for the consecutive previous calendar period 220 corresponding to the simulation period 205 can be retrieved. The prior realized energy consumption profile values are available for a time slice T2 225 of the consecutive previous calendar period 220 corresponding to the simulation period 205. Further, the prior realized energy consumption profile values are not available for time slices T3 and T4 230 of the consecutive previous calendar period 220 corresponding to the simulation period 205. The prior realized energy consumption profile values for the time slice T2 for the simulation period 205 is retrieved from the consecutive previous calendar period 220 corresponding to the simulation period 205, shown as 240.

Furthermore, one or more time slices (e.g., T3 and T4) of the simulation period 205 for which the prior realized energy consumption profile values are not available are identified (e.g., T3 and T4 are identified). In one embodiment, the unrealized energy consumption profile values for the time slices T3 and T4 235 are estimated. Lastly, the realized energy consumption profile values (e.g., T1 210), the prior realized energy consumption profile values (e.g., T2 225), and the unrealized profile values (e.g., T3 and T4 235) are used to simulate the energy consumption for the entire simulation period 205.

FIG. 3 is a flow diagram 300 illustrating a method of estimating unrealized profile values of a simulation period using synthetic profile values (as illustrated in step 140 of FIG. 1), according to an embodiment. In one embodiment, if one or more time slices of the simulation period are identified for which neither realized energy consumption profile values nor the prior realized energy consumption profile values are retrieved, then the synthetic profile values are used to estimate unrealized profile values corresponding to the identified time slices of the simulation period.

At step 310, actual energy consumption and a corresponding consumption of a synthetic profile required to estimate the unrealized profile values are computed. In one embodiment, computing the actual energy consumption and the corresponding consumption of the synthetic profile includes aggregating synthetic profile values associated with a year to compute an annual synthetic profile. For example, if the synthetic profile values are available for each 15 minutes, then one day includes 96 synthetic profile values. Similarly, for a year, 35040 synthetic profile values exist. In one exemplary embodiment, all the 35040 synthetic profile values are aggregated to determine the annual synthetic profile.

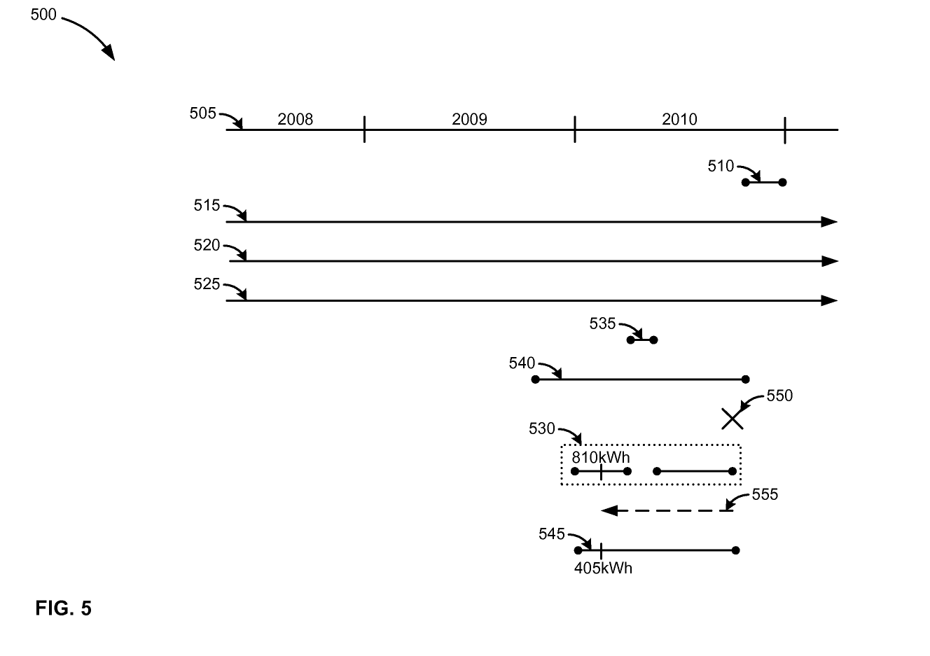

Further, the annual synthetic profile is multiplied with a minimum percentage as indicated in a tariff. The tariff includes a header data (wherein the header data includes properties of the tariff) and corresponding details (wherein the details describe computation of the tariff). In one exemplary embodiment, the minimum percentage defines a minimum energy consumption of the available realized profile values needed to estimate the unrealized profile values for the identified time slices of the simulation period as displayed in the tariff. The available realized profile values include the realized profile values of the simulation period, the prior realized profile values of the consecutive previous calendar period corresponding to the simulation period, and other realized energy consumption profile values. The available realized energy consumption profile values are described in greater detail in FIG. 5.

Furthermore, the available realized energy consumption profile values and corresponding synthetic profile values are aggregated until the aggregated synthetic profile is equal to or greater than the value resulting from the multiplication of the annual synthetic profile and the minimum percentage. The aggregated available realized energy consumption profile is the actual energy consumption. The corresponding aggregated synthetic profile is the corresponding consumption of the synthetic profile. In one exemplary embodiment, aggregating the available realized energy consumption profile values includes aggregating from a recent available realized energy consumption profile value. In other words, all the available realized energy consumption profile values are not required to determine the actual annual energy consumption for computing the energy consumption for the simulation period, but only for the defined minimum percentage in the tariff.

For example, if the available realized energy consumption profile values are available for 5 years, then aggregating the available realized energy consumption profile values of all the 5 years may increase the load on the processor. Therefore, the minimum percentage required to estimate the unrealized profile values of the simulation period is considered. If the minimum percentage is 40%, then the available realized energy consumption profile values are aggregated starting from the recent available realized energy consumption profile until the 40% of corresponding synthetic profile values is reached. Aggregating the available realized energy consumption profile values and the corresponding synthetic profile values are described in greater detail in FIGS. 5 and 6.

In one embodiment, if the minimum percentage of the available realized energy consumption profile values is not available, energy consumption corresponding to a period is considered as the actual energy consumption. The energy consumption corresponding to the period is pre-assigned to the interval register associated with the customer after inspecting energy consumption behavior of the customer.

At step 320, a scaling factor is determined by computing a ratio of the actual energy consumption with the corresponding consumption of a synthetic profile. For example, considering the actual energy consumption as 3000 kWh (kilo watt hour), and the corresponding consumption of the synthetic profile as 700 kWh (considering the annual synthetic profile as 1000 kWh), the scaling factor is computed as the ratio of the actual energy consumption and the corresponding consumption of the synthetic profile (i.e., 3000 kWh/700 kW=4.3).

At step 330, the unrealized profile values for the identified time slices are computed by multiplying each synthetic profile value of the identified time slices with the scaling factor. In other words, since the synthetic profile values are predicted arbitrary values, the synthetic profile values are scaled to the scaling factor to simulate the energy consumption of the simulation period. For example, if the scaling factor is 4.3, each synthetic profile value of the identified time slices of the simulation period, are multiplied by 4.3 to estimate the unrealized profile values for the identified time slices. Estimating the unrealized profile values is described in greater detail in FIGS. 5 and 6.

In summary, for the energy consumption simulation, where the realized energy consumption profile values or the prior realized energy consumption profile values are not available for the time slices of the simulation period, the synthetic profile values are scaled with the scaling factor to estimate the unrealized profile values corresponding to the time slices of the simulation period. Further, the retrieved realized energy consumption profile values, the retrieved prior realized energy consumption profile values, and the estimated unrealized profile values are simulated to determine the simulation for the energy consumption of the simulation period. In one embodiment, if the realized energy consumption profile values or the prior energy consumption realized profile values are available for each time slice of the simulation period, the retrieved realized energy consumption profile values and the prior realized energy consumption profile values are used to simulate energy consumption of the simulation period.

FIG. 4 is an exemplary timeline diagram 400 illustrating simulating energy consumption of a simulation period 410, according to an embodiment. A time period 405 represents period (e.g., years 2009, 2010, and 2011). In one exemplary embodiment, a complete year 2011 has to be simulated (i.e., the simulation period 410) to predict the energy consumption in the year 2011 (e.g., to determine budget billing plan). An installation 415 exists since the year 2009. Further, a new contract is created beginning of the year 2011 and a previous contract was terminated by a move-out in September 2010, shown as 420. Also, no change in energy consumption of a period 425 exists since the year 2009. Furthermore, no realized energy consumption profile values within the year 2011 exist. Prior realized energy consumption profile values 430 exist since mid of 2009 and older values were archived. For example, a smart meter is installed at the beginning of the year 2009, but the prior realized energy consumption profile values 430 are available for the time period within 2009 and 2010 only. At the beginning of the year 2011, the energy consumption for the year 2011 has to be simulated, and the computer simulates the energy consumption according to the embodiment.

In one embodiment, the realized energy consumption profile values corresponding to the simulation period 2011 are retrieved. In this example, there exist no realized energy consumption profile values within the year 2011. Further, since a customer has declared that a predicted disconnection 435 exists in the month of October 2011 (e.g., may be the customer has planned for an outing and therefore no energy consumption), unrealized profile values pertaining to October 2011 are set to zero, shown as 440. Furthermore, the prior realized energy consumption profile values from consecutive previous calendar periods (i.e., years 2009 and 2010) corresponding to the simulation period (i.e., year 2011) are retrieved. For example, the prior realized energy consumption profile values from January 2010 to September 2010 (e.g., 1000 kWh are copied to January 2011 to September 2011), shown as 445. Since, no contract exists from September 2010 to December 2010, the prior realized energy consumption profile values are not available from September 2010 to December 2010, at 450.

The prior realized energy consumption profile values for the remaining time slices (November 2011 to December 2011) of the year 2011 can be retrieved from the year 2009 based on the factors such as the installation and the contract exists in the year 2009, and the energy consumption corresponding to the period is not changed from the year 2009. Accordingly, the prior realized energy consumption profile values of November 2009 and December 2009 (e.g., 200 kWh) are copied to November 2011 and December 2011,shown as 455. Furthermore, a check is made to identify one or more time slices of the year 2011 for which the prior realized energy consumption profile values are not available. In the example, the prior realized energy consumption profile values exist for each time slice of the year 2011. Therefore, no time slice of the year 2011 is identified. Thereby, the retrieved prior realized energy consumption profile values (e.g., the prior realized energy consumption profile values of January 2011 to September 2011, November 2011 and December 2011, i.e., 1000 kWh+200 kWh) are used to simulate energy consumption for the simulation period (i.e., year 2011) (e.g., the simulated energy consumption profile 465 is 1200 kWh).

FIG. 5 is another exemplary timeline diagram illustrating simulating energy consumption of a simulation period 510, according to an embodiment. A time period 505 represents period (e.g., years 2008, 2009, and 2010). In one exemplary embodiment, a last quarter of the year 2010 (October 2010 to December 2010) is simulated (i.e., shown as the simulation period 510) to predict the energy consumption in last quarter of the year 2010 (e.g., for unbilled revenue reporting). The installation 515 and the contract 520 exist since 2008. Also, no change of energy consumption corresponding to the period 525 has occurred since the year 2008. Further, no realized energy consumption profile values within the simulation period 2010 exist. Also, prior realized energy consumption profile values of a consecutive previous calendar period (i.e., the prior realized energy consumption profile values for October 2009 to December 2009) corresponding to the simulation period 510 (i.e., October 2010 to December 2010) do not exist. However, available realized energy consumption profile values exist since January 2010 to August 2010 and older values were archived (shown as available realized energy consumption profile values 530). Furthermore, in April 2010, the interval register was disconnected 535. For example, a smart meter is installed at the beginning of the year 2008. The prior realized energy consumption profile values are available for the time period from October 2009 to December 2009. At the beginning of October 2010, the energy consumption for the months of October 2010 to December 2010 has to be simulated, and the computer simulates the energy consumption according to the embodiment.

In one embodiment, no realized energy consumption profile values exist within the simulation period 510. Further, no prior realized energy consumption profile values exist in the consecutive previous calendar year 2009 corresponding to the simulation period 510 (e.g., October 2010 to December 2010) since older values are archived. Further, one or more time slices for which the prior realized energy consumption profile values are not available are identified. In this example, each time slice in the simulation period 510 is identified. Therefore, unrealized profile values for each time slice of the simulation period 510 (e.g., October 2010 to December 2010) is estimated using synthetic values.

In one embodiment, actual energy consumption and a corresponding consumption of synthetic profile required to estimate the unrealized profile values are computed. The actual energy consumption is determined by aggregating the available energy consumption profile values 530 based on a minimum percentage needed to compute the actual energy consumption. For example, the available energy consumption profile values exist from January 2010 to September 2010 with the disconnection 535 in April 2010. The minimum percentage needed to compute the actual energy consumption is considered as 40% and the aggregated synthetic profile for a year (i.e., annual synthetic profile 540) (e.g., October 2009 to September 2010) is considered as 1000 kWh.

Further, the minimum percentage (40%) is multiplied with the annual synthetic profile 540 (1000 kWh) (i.e., 40%×1000 kWh=400 kWh). Therefore, both the available energy consumption profile values 530 and the corresponding synthetic profile values 545 are aggregated until the corresponding synthetic profile 545 is approximately 400 kWh starting from a recent available realized energy consumption profile value 550 (e.g., August 2010), shown as 555. For example, when the synthetic profile is 405 kWh, the available realized energy consumption profile gives 810 kWh. Further, a ratio of the actual annual energy consumption (e.g., 810 kWh) and the corresponding synthetic profile (405 kWh) is calculated to compute the scaling factor (e.g., 810 kWh/405 kWh=2). Further, each synthetic profile values associated with the identified time slices (e.g., October 2010 to December 2010) of the simulation period 510 is multiplied with the scaling factor (e.g., 2) to provide energy consumption simulation for the simulation period 510.

FIG. 6 is yet another exemplary timeline diagram illustrating simulating energy consumption of a simulation period 610, according to an embodiment. A time period 605 represents time periods (e.g., years 2009, 2010, and 2011). In one exemplary embodiment, a complete year 2011 is simulated (shown as the simulation period 610) to prognosis the energy consumption in the year 2011. The installation 615 exists since 2009. Further, a new contract is created beginning of the year 2011 and the previous contract was terminated by a move-out in September 2010, shown as 620. Also, no change of energy consumption corresponding to a period 625 has occurred since the year 2009. Furthermore, prior realized energy consumption profile values 630 exist since January 2010 to September 2010 and older values were archived. For example, a smart meter is installed at the beginning of the year 2009. The prior realized energy consumption profile values 630 are available from the beginning of the year 2009. At the beginning of the year 2011, the energy consumption for the complete year 2011 has to be simulated, and the computer simulates the energy consumption according to the embodiment.

In one embodiment, realized energy consumption profile values corresponding to the simulation period (e.g., year 2011) are retrieved. In this example, there exist no realized energy consumption profile values within the simulation period 610. Further, the prior realized energy consumption profile values 630 from a consecutive previous calendar period (e.g., year 2010) corresponding to the simulation period 610 are retrieved. For example, the prior realized energy consumption profile values from January 2010 to September 2010 are copied to January 2011 to September 2011, shown as 635. Further, one or more time slices for which the prior realized energy consumption profile values 630 are not available are identified. For example, time slices October 2011 to December 2011 of the simulation period 610 are identified. Therefore, unrealized profile values (e.g., shown as 640) for each time slice of the identified time slices (e.g., October 2011 to December 2011) of the simulation period is estimated using synthetic profile values as described in FIG. 2. Further, the retrieved prior realized energy consumption profile values (e.g., shown as 635), and the estimated unrealized profile values (e.g., shown as 640) are used to simulate the energy consumption 645 corresponding to the simulation period 610.

FIG. 7 is a timeline diagram 700 illustrating interpretation of energy consumption corresponding to a period for retrieving prior realized profile values of consecutive previous calendar periods corresponding to a simulation period, according to an embodiment. In one embodiment, one or more factors such as an installation, a contract, and energy consumption corresponding to a period are considered before retrieving prior realized energy consumption profile values of the consecutive previous calendar periods corresponding to the simulation period. The energy consumption corresponding to the period is assigned to an interval register associated with the customer by an authorized person of the energy provider after inspecting energy consumption behavior of the customer. Further, each customer is associated with the energy consumption corresponding to the period, based on which prior realized energy consumption profile values from the consecutive previous calendar periods corresponding to the simulation period are retrieved.

In one exemplary embodiment, simulation of energy consumption for the simulation period may not be achieved if the energy consumption corresponding to the period associated with the customer is not available. Further, the energy consumption corresponding to the period can be changed historically depending on the energy consumption behavior of the customer. Accordingly, the prior realized energy consumption profile values from the consecutive previous calendar periods corresponding to the simulation period may not be retrieved for the period after the change in the energy consumption corresponding to the period.

In one embodiment, if a minimum percentage of the available realized energy consumption profile values are not available, the energy consumption corresponding to the period is considered as an actual energy consumption, which is used to estimate unrealized profile values corresponding to the simulation period.

In one exemplary embodiment, interpreting the change in the energy consumption corresponding to the period is depicting in the timeline diagram 700 through different examples (e.g., case A to case E). A time period 705 represents one or more time periods (e.g., years 2009, 2010, and 2011). In all cases (e.g., case A to case E), a complete year 2011 is considered as the simulation period 710. Further, factors such as the installation 715 and the contract 720 are considered existing since the year 2009.

In case A, the energy consumption corresponding to the period is defined during the installation 715 of a device and not changed till a year 2011 (e.g., the energy consumption corresponding to the period is 2000 kWh), shown as 725. Therefore, the prior realized profile values of the consecutive previous calendar periods (e.g., years 2010 and 2009) can be retrieved (if the prior realized energy consumption profile values exist in the year 2010 and 2009) for simulating energy consumption for the simulation period 710.

In case B, the energy consumption corresponding to the period is defined during the installation 715 of the device and is changed at the end of the year 2011 (e.g., the energy consumption corresponding to the period is 2000 kWh till the year 2011 and is changed to 3000 kWh after the year 2011), shown as 730. Since the change in the energy consumption corresponding to the period occurs after the simulation period 710, the change is not considered. Therefore, the prior realized profile values of the consecutive previous calendar periods (e.g., years 2010 and 2009) can be retrieved (if the prior realized energy consumption profile values exist in the years 2010 and 2009) for simulating energy consumption for the simulation period 710 (e.g., the year 2011).

In case C, the energy consumption corresponding to the period is defined during the installation 715 of the device and is changed during mid of the year 2011 (e.g., the energy consumption corresponding to the period is 2000 kWh till the mid of the year 2011 and is changed to 3000 kWh after the mid of the year 2011), shown as 735. Therefore, for simulating energy consumption for first half of the year 2011, the prior realized profile values of the consecutive previous calendar periods (e.g., years 2010 and 2009) can be retrieved (if the prior realized energy consumption profile values exist in the year 2010 and 2009). However, for simulating energy consumption for second half of the year 2011, the prior realized profile values of the consecutive previous calendar periods (e.g., years 2010 and 2009) cannot be retrieved. The energy consumption simulation for the second half of the year 2011 is achieved by scaling synthetic profile values associated with the second half of the year 2011 to 3000 kWh.

In case D, the energy consumption corresponding to the period is defined during the installation 715 of the device and is changed during a month of December 2010 (e.g., the energy consumption corresponding to the period is 2000 kWh till December 2010 and is changed to 3000 kWh after December 2010), shown as 740. Therefore, for simulating energy consumption for December 2011 of the simulation period 710, the prior realized profile values of December 2010 of the consecutive previous calendar periods can be retrieved (if the prior realized energy consumption profile values exist for December 2010). However, for simulating energy consumption for other months of the simulation period 710 (e.g., months January 2011 to November 2011), synthetic profile values associated with the months January 2011 to November 2011 is scaled to 3000 kWh.

In case E, the energy consumption corresponding to the period is defined during the installation 715 of the device and is changed in the year 2009 (e.g., the energy consumption corresponding to the period is 2000 kWh till December 2009 and is changed to 3000 kWh after December 2010), shown as 745. Therefore, the prior realized profile values of the consecutive previous calendar periods (e.g., years 2010) can be retrieved (if the prior realized energy consumption profile values exist in the year 2010) for simulating energy consumption for the simulation period 710 (e.g., the year 2011).

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

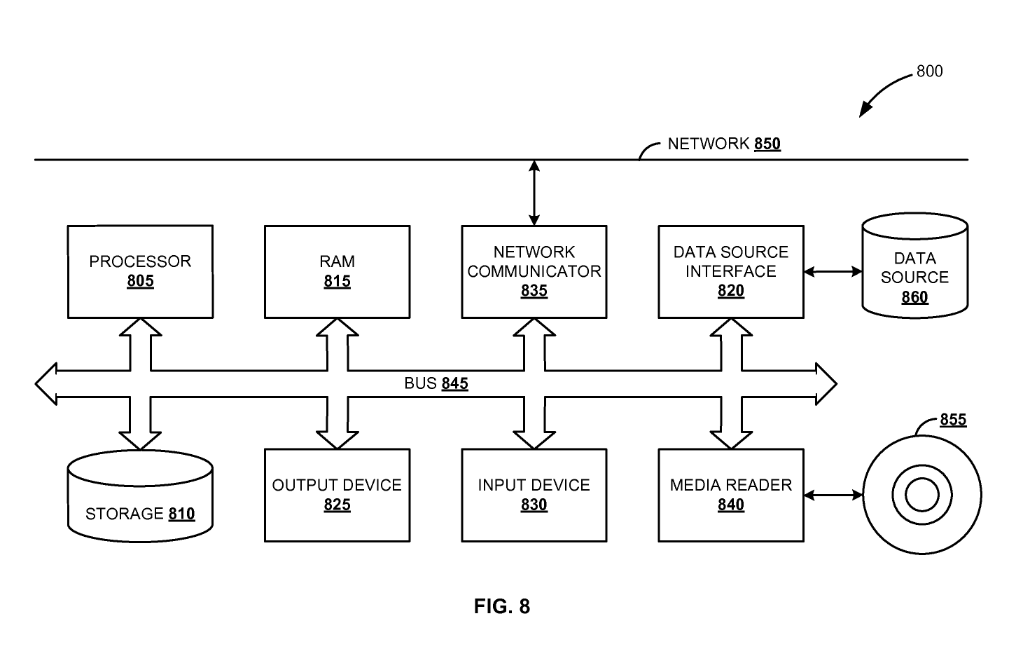

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a tangible computer readable storage medium to physically store instructions, which when executed by a computer, cause the computer to:
retrieve realized energy consumption profile values for time slices of a simulation period;
retrieve prior realized energy consumption profile values from corresponding time slices of consecutive previous calendar periods for time slices of the simulation period for which the realized energy consumption profile values are not available;
identify one or more time slices of the simulation period for which the corresponding prior realized profile values are not available;
for the identified time slices, compute an estimation of the unrealized energy profile values using synthetic profile values; and
simulate energy consumption for the simulation period using the retrieved realized energy consumption profile values of the simulation period, the retrieved prior realized energy consumption profile values of the consecutive previous calendar periods, and the estimated unrealized energy profile values of the simulation period.

2. The article of manufacture of claim 1, wherein retrieving the prior realized energy consumption profile values is based on one or more factors including a contract, an installation and energy consumption corresponding to a period.

3. The article of manufacture of claim 1, further comprising instructions to cause the computer to:
if the one or more time slices of the simulation period are not identified, simulate the energy consumption for the simulation period using the retrieved realized energy consumption profile values of the simulation period and the retrieved prior realized energy consumption profile values of the consecutive previous periods.

4. The article of manufacture of claim 1, wherein the synthetic profile values are created based on one or more energy consumption patterns associated with a customer.

5. The article of manufacture of claim 1, wherein computing the estimation of the unrealized energy profile values for the identified time slices of the simulation period comprises:
computing actual energy consumption and a corresponding consumption of a synthetic profile required to estimate the unrealized profile values;
determining a scaling factor by computing a ratio of the actual energy consumption with the corresponding consumption of the synthetic profile value; and
computing the unrealized profile values for the identified time slices by multiplying each synthetic profile value associated with the identified time slices with the scaling factor.

6. The article of manufacture of claim 5, wherein computing the actual energy consumption and the corresponding consumption of the synthetic profile comprises:
aggregating synthetic profile values associated with a year to compute an annual synthetic profile;
multiplying the annual synthetic profile with a minimum percentage as indicated in a tariff; and
aggregating available realized energy consumption profile values and corresponding synthetic profile values until the aggregated synthetic profile is equal to or greater than the resulted value of the multiplication to compute the actual energy consumption and the corresponding consumption of the synthetic profile.

7. The article of manufacture of claim 6, wherein the minimum percentage defines a minimum value of the available realized energy consumption profile values needed to compute the unrealized profile values for the identified time slices of the simulation period.

8. The article of manufacture of claim 6, wherein the available realized energy consumption profile values comprises the realized energy consumption profile values within the simulation period, the prior realized energy consumption profile values of the consecutive previous calendar periods corresponding to the simulation period, other realized energy consumption profile values.

9. The article of manufacture of claim 6, wherein aggregating the available realized energy consumption profile values comprises aggregating from a last realized energy consumption profile value.

10. The article of manufacture of claim 6, wherein when the minimum percentage of the available realized energy consumption profile values are not available, energy consumption corresponding to a period is considered to compute the unrealized profile values for the identified time slices of the simulation period.

11. The article of manufacture of claim 10, wherein the energy consumption corresponding to the period is energy consumption assigned to a register associated with the customer.

12. A computer implemented method for simulating energy consumption for a simulation period, the method comprising:
retrieving realized energy consumption profile values for time slices of the simulation period;
retrieving prior realized energy consumption profile values from corresponding time slices of consecutive previous calendar periods for time slices of the simulation period for which the realized energy consumption profile values are not available;
identifying one or more time slices of the simulation period for which the corresponding prior realized profile values are not available;
for the identified time slices, computing an estimation of the unrealized energy profile values using synthetic profile values; and
simulating the energy consumption for the simulation period using the retrieved realized energy consumption profile values of the simulation period, the retrieved prior realized energy consumption profile values of the consecutive previous calendar periods, and the estimated unrealized energy profile values of the simulation period.

13. The computer implemented method of claim 12, wherein retrieving the prior realized energy consumption profile values is based on one or more factors including a contract, an installation and energy consumption corresponding to the period.

14. The computer implemented method of claim 12, further comprising:
if the one or more time slices of the simulation period are not identified, simulate the energy consumption for the simulation period using the retrieved realized energy consumption profile values of the simulation period and the retrieved prior realized energy consumption profile values of the consecutive previous periods.

15. The computer implemented method of claim 12, wherein the synthetic profile values are created based on one or more energy consumption patterns associated with a customer.

16. The computer implemented method of claim 12, wherein computing the estimation of the unrealized energy profile values for the identified time slices of the simulation period comprises:
computing actual energy consumption and a corresponding consumption of synthetic profile required to estimate the unrealized profile values;
determining a scaling factor by computing a ratio of the actual energy consumption with the corresponding consumption of the synthetic profile; and
computing the unrealized profile values for the identified time slices by multiplying each synthetic profile value associated with the identified time slices with the scaling factor.

17. The computer implemented method of claim 16, wherein computing the actual energy consumption and the corresponding consumption of the synthetic profile comprises:
aggregating synthetic profile values associated with a year to compute an annual synthetic profile value;
multiplying the annual synthetic profile with a minimum percentage as indicated in a tariff; and
aggregating available realized energy consumption profile values and corresponding synthetic profile values until the aggregated synthetic profile is equal to or greater than the resulted value of the multiplication to compute the actual energy consumption and the corresponding synthetic profile value.

18. The computer implemented method of claim 17, wherein the minimum percentage defines a minimum value of the available realized energy consumption profile values needed to compute the unrealized profile values for the identified time slices of the simulation period.

19. The computer implemented method of claim 17, wherein the available realized energy consumption profile values comprises the realized energy consumption profile values within the simulation period, the prior realized energy consumption profile values of the consecutive previous calendar periods corresponding to the simulation period, other realized energy consumption profile values.

20. The computer implemented method of claim 17, wherein aggregating the available realized energy consumption profile values comprises aggregating from a last realized energy consumption profile value.

21. The computer implemented method of claim 17, wherein when the minimum percentage of the available realized energy consumption profile values are not available, energy consumption corresponding to a period is considered to compute the unrealized profile values for the identified time slices of the simulation period.

22. The computer implemented method of claim 21, wherein the energy consumption corresponding to the period is energy consumption assigned to a register associated with the customer.

23. A computer system for simulating energy consumption for a current energy simulating period, the computer system comprising a processor, the processor communicating with one or more memory devices storing instructions, the instructions operable to:
retrieve realized energy consumption profile values for time slices of the simulation period;
retrieve prior realized energy consumption profile values from corresponding time slices of consecutive previous calendar periods for time slices of the simulation period for which the realized energy consumption profile values are not available;
identify one or more time slices of the simulation period for which the corresponding prior realized profile values are not available;
for the identified time slices, compute an estimation of the unrealized energy profile values using synthetic profile values; and
simulate the energy consumption for the simulation period using retrieved realized energy consumption profile values of the simulation period, the retrieved prior realized energy consumption profile values of the consecutive previous calendar periods, and the estimated unrealized energy profile values of the simulation period.

24. The computer system of claim 23, wherein retrieving the prior realized energy consumption profile values is based on one or more factors including a contract, an installation and energy consumption corresponding to a period.

25. The computer system of claim 21, further comprising instructions operable to:
if the one or more time slices of the simulation period are not identified, simulate the energy consumption for the simulating period using the retrieved realized energy consumption profile values of the simulation period and the retrieved prior realized energy consumption profile values of the consecutive previous.

26. The computer system of claim 21, wherein computing the unrealized profile values for the one or more time slices of the energy simulation period comprises:
computing actual energy consumption and a corresponding consumption of a synthetic profile required to estimate the unrealized profile values;
determining a scaling factor by computing a ratio of the actual energy consumption with the corresponding consumption of the synthetic profile; and
computing the unrealized profile values for the identified time slices by multiplying each synthetic profile value associated with the identified time slices with the scaling factor.
